(19) United States
(12) Patent Application Publication
(10) Pub. No.: US 2020/0325057 A1
(43) Pub. Date: Oct. 15, 2020

(54) GLASS FORMING FURNACE

(71) Applicant: CORNING INCORPORATED, CORNING, NY (US)

(72) Inventors: Steven Roy Burdette, Big Flats, NY (US); Laurent Joubaud, Paris (FR); Eric Lee Miller, Corning, NY (US); Jason Scott Stewart, Hornell, NY (US); Zheming Zheng, Horseheads, NY (US)

(21) Appl. No.: 16/848,292

(22) Filed: Apr. 14, 2020

Related U.S. Application Data
(60) Provisional application No. 62/834,035, filed on Apr. 15, 2019.

(51) Int. Cl. C03B 23/025

(52) U.S. Cl. CPC C03B 23/0258; C03B 23/0252

(57) ABSTRACT

Disclosed herein are glass forming furnaces and methods of using the same. The glass forming furnaces may include a housing and a bending ring. The housing may define a chamber. The bending ring may include a first inlet port, a first outlet port, and a channel. The bending ring may be located within the chamber. The channel may have a shape that is similar to a shape of a glass article. The channel may define a cavity fluidly connecting the first inlet port and the first outlet port.

### CROSS-REFERENCE TO RELATED APPLICATIONS

This application claims the benefit of priority under 35 U.S.C. § 119 of U.S. Provisional Application Ser. No. 62/834,035 filed on Apr. 15, 2019 the content of which is relied upon and incorporated herein by reference in its entirety.

### BACKGROUND

Forming various glass articles may require glass panels to be heated in a furnace. The heating may be non-uniform. In addition, the points where the glass panels are supported may result in further non-uniformity in the heating and cooling processes. Furthermore, the points where the glass panels are supported may cause additional stresses within the glass panels during the heating and cooling processes.

### SUMMARY

Disclosed herein are glass forming furnaces and methods of using the same. The glass forming furnaces may include a housing and a bending ring. The housing may define a chamber. The bending ring may include a first inlet port, a first outlet port, and a channel. The bending ring may be located within the chamber. The channel may have a shape that is similar to a shape of a glass article. The channel may define a cavity fluidly connecting the first inlet port and the first outlet port.

### BRIEF DESCRIPTION OF THE FIGURES

The drawings illustrate generally, by way of example, but not by way of limitation, various embodiments discussed herein.

FIG. 1 shows a furnace consistent with example embodiments disclosed herein.

FIG. 2 shows a bending ring consistent with example embodiments disclosed herein.

FIG. 3 shows a plurality of bending rings consistent with example embodiments disclosed herein.

FIGS. 4, 5, 6, 7, and 8 show edge stress profiles for bending rings consistent with example embodiments disclosed herein.

FIG. 9 shows a method consistent with example embodiments disclosed herein.

Like reference numbers in the various figures indicate like elements. Some elements may be present in identical or equivalent multiples; in such cases only one or more representative elements may be designated by a reference numeral, but it will be understood that such reference numbers apply to all such identical elements. Unless otherwise indicated, all figures and drawings in this document are not to scale and are chosen for the purpose of illustrating different embodiments of the present disclosure. In particular, the dimensions of the various components are depicted in illustrative terms only, and no relationship between the dimensions of the various components should be inferred from the drawings, unless so indicated. Although terms such as “top,” “bottom,” “upper,” “lower,” “under,” “over,” “front,” “back,” “up,” “down,” “first,” “second,” etc. may be used in this disclosure, it should be understood that those terms are used in their relative sense only unless otherwise noted.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Gravity sagging of thin glass to make articles, such as automotive glazing parts that may include windshields and roofs, may require heating the glass part non-uniformly. For instance, the center of the part may be heated to a higher temperature than its edges. This may be done to address a phenomenon known as “bathtub” in which the edge region of the glass part may be over-sagged compared to the target shape and the center of the part may be flat and under-sagged, resulting in a bathtub like shape. Experimental and modeling studies have shown that compared to conventional thick glass (e.g., 3.2 mm and 5.0 mm thick glass), thinner glass (e.g., less than or equal to 1.0 mm thick) has a greater propensity to edge over-sagging and edge wrinkling. It is therefore critical to manage and control the temperature of the edge during thin glass bending.

To achieve specified shapes for glass article, a temperature difference between the center and the edge of the glass panel (sometimes referred to as the part) in excess of ΔT=80° C. may need to be maintained. Low edge temperatures may help mitigate over-sagging in the edge region whereas high center temperature may enable achieving the desired curvature and depth of bend in the part center.

As disclosed herein, in a gravity sagging process the desired ΔT on the part may be achieved in a number of ways. First, heater settings in a final preheat and bending zones where higher power may be applied to the heaters, which may be located directly above and below the central region of the part. Second, cooling of a bending ring may be used during the process.

As disclosed herein, the bending ring may be cooled by passing a fluid, such as a gas or liquid, through the tube and may result in improved process capabilities. First, maintaining a cooler bending ring may result in a cooler glass edge which may assist the thin glass ply in buckling resistance, and second, the ability to control the temperature of the ring may enable control of the local glass temperature near the edge of the glass where critical stress related attributes develop. For example, edge stress, which may be a product attribute for windshields, may be generated upon cooling due as the glass exiting the highest temperature bending zone of the furnace and while the material is transitioning from a visco-elastic state to an elastic state. Temperature differential from regions supported and unsupported may produce tensile and compressive regions.

Another way to help maintain a desired temperature difference may include using heat shields or insulation in conjunction with cooled bending rings. Heat shields, which may be metal or ceramic plates with a central aperture, that may reside on top and bottom of the glass part throughout the bending process. Insulation may include glass fibers or other ceramic or fibrous material that may be used to wrap portions of the bending tubes to hinder heating of the bending ring while inside a furnace. The heat shields and insulation may block radiation heat transfer from heating elements located within the furnace to the edge region of glass. The heat shields and/or insulation may be used to insulate the bending rings and the cooling system that supplies fluid to the bending rings. The aperture at the center may allow radiation heat transfer from the top and bottom heating elements to the center of the part, thus achieving a thermal gradient on the glass part.

Current bending rings are not temperature controlled. Typically, their mass, density, thermal conductivity, and geometry dictate their temperature as a function of time within the furnace. Traditionally, changes have been made to the ring to effect or improve edge stress results. These include changing the geometry and thickness of the ring or covering the bending ring with high temperature cloth or coating to reduce radiative heating of the ring and outgoing conduction, thereby minimizing its peak temperature after leaving the bending zones of the furnace. These approaches however, do not allow for precise control of temperature.

As disclosed herein, a fluid supply system located external to a chamber defined by a furnace may supply a gas, liquid, or combination of the two that may be circulated through a bending ring located inside the furnace. An interface system that may include couplings, valves, or other flow control items may be used to connect the fluid supply system to the bending ring.

By supplying the fluid at a range of pressures and temperatures, ring temperature may be controlled in-zone to reduce the introduction of high tensile stress inboard of the glass edge. Fluid temperatures and flow rates may be measured and modified to control bending ring temperature to reduce defects that could occur in supported glass sheets. For example, by measuring and adjusting fluid temperatures and flow rates may result in reduced wrinkling and edge stress deviations from specification during the glass forming process.

For process temperature control, the bending ring may be cooled to room temperature after exiting the furnace by passing a fluid through the bending ring as disclosed herein. Typically, natural convection and average dwell times outside of the furnace do not provide enough time to cool the ring to room temperature. Typical ring temperatures reach ˜150° C. after leaving the existing CETC furnace. Experiments have shown that forcing the ring to lower temperature after exiting (˜50° C.), ensures the ring will not reach as high of a maximum temperature and produce improved stress results. The result may be that controlling bending ring temperature in zones may allow for the establishment of proper tensile and compressive edge stress.

Advantages of the systems and methods disclosed herein may include, among other things, the ability to close the loop on gas flow to maintain a ring temperature; the ability to control ring temperature precisely in zones where wrinkling/buckling propensity may be high; the ability to change ring geometries while still maintaining target glass temperature; and the ability to rapidly reduce ring temperature upon furnace exit and thus producing a cooler peak temperature ring in key bending zones. The systems and methods disclosed herein also allow for a low cost approach to managing ring temperature without significant modifications to existing furnaces.

The ability to control the temperature of a bending ring allows for at least two areas of process improvement in glass bending: wrinkling and edge stress.

With respect to wrinkling, as the glass and ring convey throughout the bending furnace, the glass and ring heat up and cool down at different rates due to geometry, heat capacity, emissivity, and other factors. On heat-up, and in bending, if the temperature of the glass reaches a critical temperature where viscosity is sufficiently reduced and bending stresses reach a critical threshold, the thin ply sheet may buckle. Current approaches allow for significant reduction in temperatures (˜80° C.), but effect a large area, and thus, only reduce temperature through radiative blocking while retaining heat in cooling, which reduces potential for thermal tempering of edges. Bending ring temperature control as disclosed herein via fluid flow through the bending ring may allow for reduction of local glass temperature through conduction, and thereby increase glass viscosity and increase buckling resistance.

With respect to edge stress, after bending has occurred, the rate at which the glass and bending ring cool until reaching glass transition temperature effects the stress distribution with about 50 mm of the edge of the glass panel. Product requirements may dictate a maximum tensile stress, such as about 5 MPa and minimum compressive stress of about −10 MPa. Experiments have shown that maintaining a cooler bending ring upon furnace entry using the systems and methods disclosed herein results in reduced peak tensile stress.

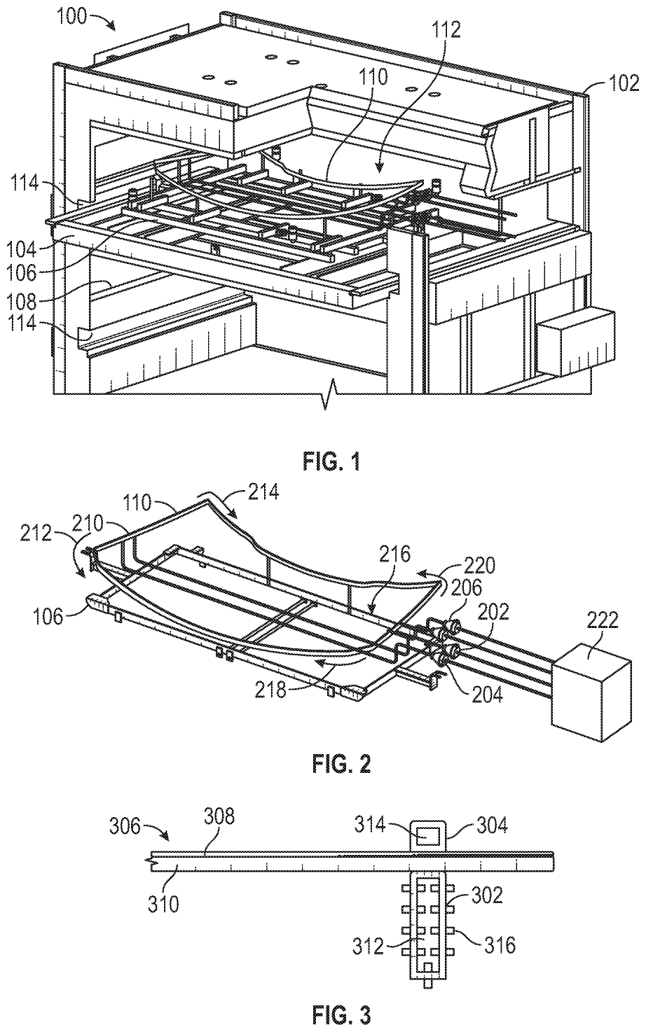

Turning now to the figures, FIG. 1 shows a furnace 100 for forming a glass article consistent with example embodiments disclosed herein. Furnace 100 may include a housing 102, a tray 104, a support structure 106, a heating element 108, and a bending ring 110. The housing 102 may define a cavity 112 that houses tray 104, support structure 106, heating element 108, and bending ring 110. Housing 102 may be one stage of many that make up a glass forming process. Each of the stages may heat glass to different temperatures as part of the glass forming process.

Bending ring 110 may be attached to tray 104. Housing 102 may define one or more grooves 114 that may receive one or more of trays 104. As a result, furnace 100 may be able to form more than one panel of glass at a time. This may increase process efficiency by allowing more than one glass part to be bent during a heating process. In addition, different bending rings may be used so that multiple components with different shapes or contours may be formed simultaneously. As disclosed herein, support structure 106 may include one or more heat shields. In addition, bending ring 110 may include insulation to help control heat transfer and temperature of the bending ring and glass panel supported thereon.

As shown in FIGS. 1 and 2, bending ring 110 may have a contour that matches a contour of a desired glass article. For example, bending ring 110 may have a contour that matches a contour needed for a windshield. As a result, as a glass panel is heated, the glass panel may sag, flex, bend, etc. to conform to the contour of bending ring 110 and thus, have the desired shape needed for the windshield.

Bending ring 110 may define a channel. As disclosed herein, the channel may allow a fluid to pass through bending ring 110. For example, and as shown in FIG. 2, bending ring 110 may include a first inlet 202, a second inlet 204, a first outlet 206, and a second outlet 208. The channel defined by bending ring 110 may fluidly connect first inlet 202 to first outlet 206 and second inlet 204 to second outlet 208. In addition, first inlet 202 and second inlet 204 each may be fluidly connected to both first outlet 206 and second outlet 208. Stated another way, the channel may be a continuous channel that has multiple inlets and outlets.

As shown in FIG. 2, first inlet 202 and second inlet 204 may be connected proximate a midpoint 210 of bending ring 110. As a result, the fluid that flows through bending ring 110 may flow in multiple directions. For example, the configuration shown in FIG. 2 may allow for the fluid to flow in two directions as shown by arrows 212 and 214. This may result in the fluid flowing approximately halfway through bending ring 110 in each direction.

The inlets and outlets shown in FIG. 2 may be reversed. For example, first outlet 206 and second outlet 208 may act as inlets and first inlet 202 and second inlet 204 may act as outlets. As a result, the fluid may enter bending ring 110 proximate point 216 and flow through bending ring 110 as indicated by arrows 218 and 220.

The fluid that flows through bending ring 110 may be supplied by a supply system 222. Supply system 222 may include a controller that may monitor the inlet and exit temperatures of the fluid. Using the inlet and exit temperatures, the controller may increase or decrease a fluid flowrate to achieve a desired temperature within the channel. In addition, the controller may receive temperature data from bending ring 110. For example, thermocouples or other temperature sensing devices may be connected to bending ring 110 at various locations so as to allow the controller of supply system 222 to create a temperature profile of bending ring 110. Based on the temperature profile, supply system 222 may cause pumps associated with supply system 222 to increase or decrease a flowrate to achieve a desired temperature profile.

Supply system 222 may also include a refrigeration system or other cooling system that may allow supply system 222 to recirculate the same fluid though bending ring 110. In addition, supply system 222 may be connected to or include a supply source that allows fresh fluid to be circulated through bending ring 110 without recirculation.

As shown in FIG. 3, a first bending ring 302 and a second bending ring 304 may be located on opposite sides of a glass panel 306. Glass panel 306 may include a first glass layer 308 and a second glass layer 310, which may be laminated together. First glass layer 308 and second glass layer 310 may be the same or different types of glass and may have the same or different thicknesses. For example, first glass layer 308 may be a tempered glass and second glass layer 310 may be soda lime glass that is not tempered.

As shown, first bending ring 302 may define a first channel 312 and second bending ring 304 may define a second channel 314. First bending ring and first channel 312 may be the same size and shape of second bending ring 304 and second channel 314 or they may be different sizes and shapes.

In addition, first bending ring 302 may define one or more extended surfaces 316. Extended surfaces 316 may be located on an interior surface, exterior surface, or both of first bending ring 302. While not shown, second bending ring 304 may include extended surfaces in a similar, or different, configuration as first bending ring 302.

As shown in FIG. 3, first bending ring 302 and second bending ring 304 may be located and contact glass panel 306 opposite one another. Still consistent with embodiments disclosed herein, first bending ring 302 and second bending ring 304 may contact glass panel 306 on the same side. For example, first bending ring 302 and second bending ring 304 may contact second glass layer 310 and support it within cavity 112.

First bending ring 302 and second bending ring 304 may be connected to a supply system, such as supply system 222. Fluid flow through first bending ring 302 and second bending ring 304 may be parallel flow or may be counter flow. For example, flow through first bending ring 302 may be in a clockwise direction and flow through second bending ring 304 may be in a counterclockwise direction.

The channels formed by bending rings disclosed herein may have uniform and non-uniform cross-sectional areas. For example, as shown in FIG. 3, first bending ring 302 may have a rectangular cross-sectional area and second bending ring 304 may have a square cross-sectional area. The cross-section may be other shapes such as, circular, triangular, etc. The cross-section may be constant throughout the bending rings. The cross-section may vary throughout the bending rings also. For example, the fluid may enter the bending rings at a portion of the bending rings that has a cross-sectional area of X square inches and exit the bending rings at a portion of the bending rings that has a cross-sectional area of Y square inches. X may be greater than or less than Y. Portions in between X and Y may have different cross-sectional areas too. As a result, the cross-sectional area of the channels may vary to help maintain a desired temperature profile.

Portions of bending rings may form constrictions that form a capillary tube or include a throttling valve. The capillary tube or throttling valve may cause a pressure drop within the bending rings and therefore cause a temperature drop within the fluid in the bending rings.

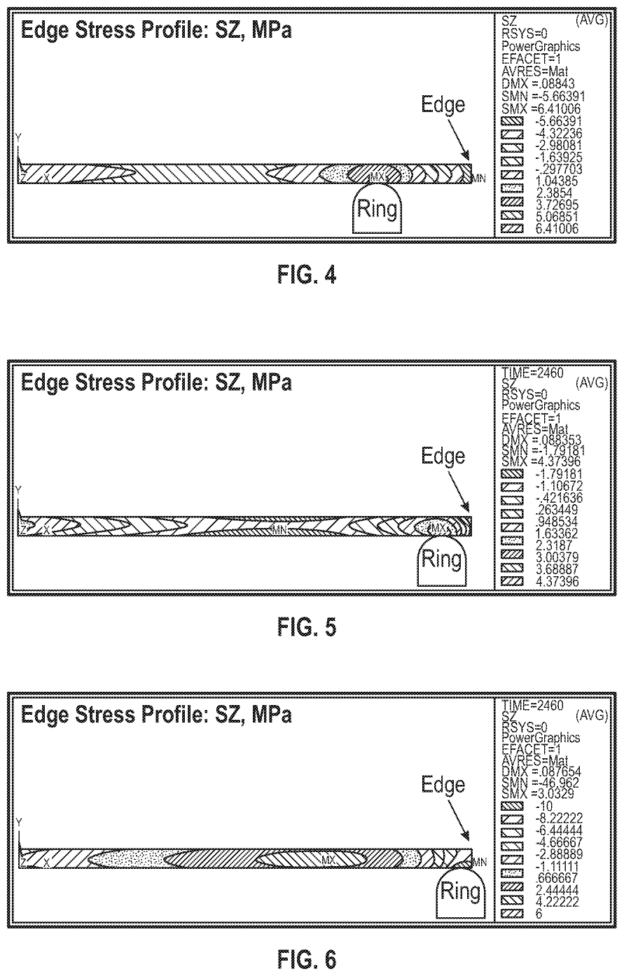

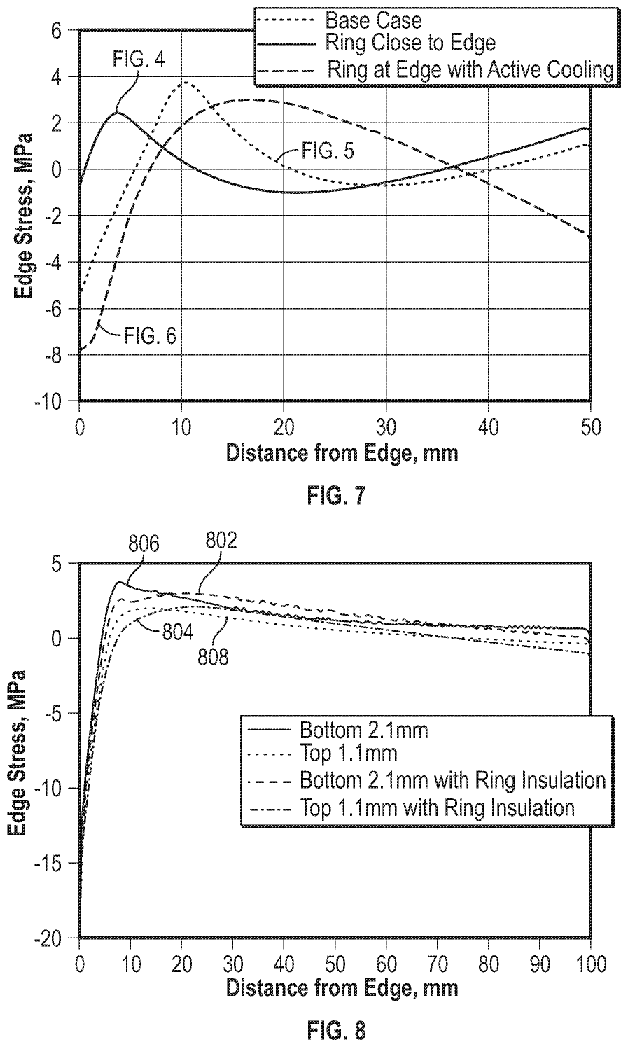

FIGS. 4, 5, and 6 show edge stress profiles for bending rings consistent with example embodiments disclosed herein. As shown in FIGS. 4, 5, and 6 the design of bending rings disclosed herein may allow for sufficient fluid flow through the bending rings and the ability to pipe fluid into and out of the bending rings without disturbing air flows within the furnace.

FIGS. 4, 5, and 6 show finite element analysis (FEA) simulation results for edge stress for different conditions. FIG. 4 represents a base case. FIG. 5 shows a case where the bending ring is moved close to the edge of a glass panel. FIG. 6 shows a case where the bending ring is moved to the edge of the glass panel and kept cold during the cycle. FIG. 7 shows plots for center line stress profiles for the three cases shown in FIGS. 4, 5, and 6. As shown in FIG. 7, with the bending ring moved to the edge of the glass panel and kept cold (curve FIG. 6), both compressive stress and tensile stress are improved over the base case (curve FIG. 4).

FIG. 8 shows edge stress as a function of distance from an edge of a glass panel for an insulated bending ring. The data for FIG. 8 is for a laminate including a stack of 1.1 mm SLG glass over 2.1 mm SLG glass. Curves 802 and 804 show the case when the bending ring is insulated (reduced heat transfer and emissivity in modeling). Curves 806 and 808 show the same stack without insulating the bending rings. As a result of insulating the bending ring, the bending ring reaches a lower peak temperature in the end of heating, and also cools slower during a cooling phase. As shown in FIG. 8, the ring insulation both reduces the tension and increases the compression stresses.

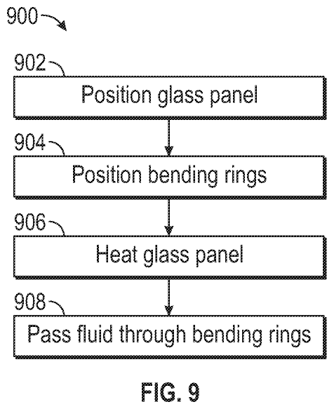

FIG. 9 shows a method 900 for forming a glass article consistent with example embodiments disclosed herein. Method 900 may include stage 902 where a glass panel may be positioned. For example, a bending ring, such as any of the bending rings disclosed herein, may be located within a furnace, such as furnace 100, and a glass panel may be positioned within the furnace and rest on a bending ring.

Method 900 may further include stage 904 where bending rings may be positioned. For example, in stage 902 instead of positioning the glass panel on a bending ring, the glass panel may be supported by supports and a bending ring may be positioned under the glass panel. In stage 902 the glass panel may be positioned on a first bending ring and in stage 904 a second bending ring may be positioned on an opposite side of the glass panel as disclosed herein. The second bending ring may also be positioned on the same side of the glass panel as disclosed herein.

Method 900 may further include stage 906 where the glass panel may be heated. For instance, to cause the glass panel to sag, flex, or otherwise conform to the shape of the bending rings, the glass panel may be heated using heating elements, such as heating elements 108, to a transition temperature where the glass panel becomes pliable and is able to be bent to match the contour defined by the bending rings.

Method 900 may further include stage 908 where a fluid may be passed through the bending rings. For example, as disclosed herein, a fluid, such as a gas or liquid may flow through the bending rings so as to cool both the bending rings and portions of the glass panel in contact with and proximate to the bending rings.

The various stages of method 900 may be implemented in different orders than as described above without departing from the scope of the disclosure. For example, stage 906 may be implemented before the bending rings are placed in a furnace and the glass heated. As such, the bending ring may be cooled before stage 904 where the glass is heated. In addition, the fluid may be passed through the bending ring during multiple stages such as during heating of the glass panel (stage 906) and when the glass panel is positioned (stage 902), and when the bending ring is positioned (stage 904).

Passing the fluid through the bending ring (stage 908) may also include passing a heated fluid through the bending ring upon removing the glass panel from a furnace so as to prevent the bending ring from cooling faster than the glass panel.

As disclosed herein, method 900 may be implemented in a single chamber furnace, a multi-chamber furnace, a furnace with multiple zones, etc. For example, one or more bending rings as disclosed herein may be transported on a wagon to various zones or chambers during a glass forming process and a fluid can be passed though the one or more bending rings to achieve a desired temperature configuration as disclosed herein.

### EXAMPLES

The present disclosure provides for the following example embodiments, the numbering of which is not to be construed as designating levels of importance.

Example 1 is a glass forming furnace for forming a glass article, the glass forming furnace comprising: a housing defining a chamber; and a first bending ring located within the chamber, the first bending ring comprising: a first inlet port, a first outlet port, and a first channel having a shape that is similar to a shape of the glass article, the first channel defining a cavity fluidly connecting the first inlet port and the first outlet port.

In Example 2, the subject matter of Example 1 optionally includes wherein the first bending ring further comprises: a second inlet port located proximate the first inlet port; and a second outlet port located proximate the first outlet port, wherein the cavity fluidly connects the second inlet port and the second outlet port.

In Example 3, the subject matter of Example 2 optionally includes wherein fluid flow between the first inlet port and the first outlet port traverses approximately a first half of the cavity and fluid flow between the second inlet port and the second outlet port traverses approximately a second half of the cavity.

In Example 4, the subject matter of any one or more of Examples 1-3 optionally include wherein a first fluid flow between the first inlet port and the first outlet port is counter to a second fluid flow between the second inlet port and the second outlet port.

In Example 5, the subject matter of any one or more of Examples 1-4 optionally include a heat source located within the housing; and a heat shield located in between the first bending ring and the heat source.

In Example 6, the subject matter of any one or more of Examples 1-5 optionally include a second bending ring located within the chamber, the second bending ring comprising: a second inlet port; a second outlet port; and a second channel having a shape that is similar to a shape of the glass article, the second channel defining a cavity fluidly connecting the second inlet port and second outlet port.

In Example 7, the subject matter of any one or more of Examples 1-6 optionally include wherein the first bending ring further comprises a plurality of extended surfaces.

In Example 8, the subject matter of Example 7 optionally includes wherein the extended surfaces are located within the cavity.

In Example 9, the subject matter of any one or more of Examples 7-8 optionally include wherein the extended surfaces are located exterior to the cavity.

In Example 10, the subject matter of any one or more of Examples 1-9 optionally include wherein the cavity has a uniform cross-sectional area.

In Example 11, the subject matter of any one or more of Examples 1-10 optionally include wherein the cavity has a non-uniform cross-sectional area.

In Example 12, the subject matter of any one or more of Examples 1-11 optionally include a throttling device located within the first channel.

Example 13 is a glass forming furnace for forming a glass article, the glass forming furnace comprising: a housing defining a chamber; and a bending ring located within the chamber, the bending ring comprising: a channel having a shape that is similar to a shape of the glass article, the channel defining a cavity, first and second inlet ports, located proximate a midpoint of the cavity, and first and second outlet ports fluidly connected to the first and second inlet ports, the first and second outlet ports located proximate respective first and second endpoints of the cavity.

In Example 14, the subject matter of Example 13 optionally includes a heat source located in the housing; and a heat shield located in between the bending ring and the heat source.

In Example 15, the subject matter of any one or more of Examples 13-14 optionally include wherein the bending ring further comprises a plurality of extended surfaces.

Example 16 is a method of forming a glass article, the method comprising: positioning a glass panel on a first bending ring located inside a glass forming furnace; heating the glass panel within the glass forming furnace; and passing a fluid through a cavity defined by the first bending ring so as to cool a portion of the glass panel in contact with the first bending ring.

In Example 17, the subject matter of Example 16 optionally includes wherein positioning the glass panel includes positioning the glass panel such that the first bending ring is located proximate edges of the glass panel.

In Example 18, the subject matter of any one or more of Examples 16-17 optionally include wherein passing the fluid through the cavity includes passing the fluid in multiple directions through various portions of the cavity.

In Example 19, the subject matter of any one or more of Examples 16-18 optionally include positioning a second bending ring to contact the glass panel; and passing the fluid through a cavity defined by the second bending ring so as to cool the portion of the glass panel in contact with the second bending ring.

In Example 20, the subject matter of Example 19 optionally includes wherein positioning the second bending ring includes positioning the second bending ring on an opposite side of the glass panel from the first bending ring.

In Example 21, the articles or methods of any one of or any combination of Examples 1-20 are optionally configured such that all elements or options recited are available to use or select from.

Values expressed in a range format should be interpreted in a flexible manner to include not only the numerical values explicitly recited as the limits of the range, but also to include all the individual numerical values or sub-ranges encompassed within that range as if each numerical value and sub-range were explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods described herein, the steps can be carried out in any order without departing from the principles of the present disclosure, except when a temporal or operational sequence is explicitly recited. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

What is claimed is:

1. A glass forming furnace for forming a glass article, the glass forming furnace comprising:
a housing defining a chamber; and
a first bending ring located within the chamber, the first bending ring comprising:
a first inlet port,
a first outlet port, and
a first channel having a shape that is similar to a shape of the glass article, the first channel defining a cavity fluidly connecting the first inlet port and the first outlet port.

2. The glass forming furnace of claim 1, wherein the first bending ring further comprises:
a second inlet port located proximate the first inlet port; and
a second outlet port located proximate the first outlet port,
wherein the cavity fluidly connects the second inlet port and the second outlet port.

3. The glass forming furnace of claim 2, wherein fluid flow between the first inlet port and the first outlet port traverses approximately a first half of the cavity and fluid flow between the second inlet port and the second outlet port traverses approximately a second half of the cavity.

4. The glass forming furnace of claim 1, wherein a first fluid flow between the first inlet port and the first outlet port is counter to a second fluid flow between the second inlet port and the second outlet port.

5. The glass forming furnace of claim 1, further comprising:
a heat source located within the housing; and
a heat shield located in between the first bending ring and the heat source.

6. The glass forming furnace of claim 1, further comprising a second bending ring located within the chamber, the second bending ring comprising:
a second inlet port;
a second outlet port; and
a second channel having a shape that is similar to a shape of the glass article, the second channel defining a cavity fluidly connecting the second inlet port and second outlet port.

7. The glass forming furnace of claim 1, wherein the first bending ring further comprises a plurality of extended surfaces.

8. The glass forming furnace of claim 7, wherein the extended surfaces are located within the cavity.

9. The glass forming furnace of claim 7, wherein the extended surfaces are located exterior to the cavity.

10. The glass forming furnace of claim 1, wherein the cavity has a uniform cross-sectional area.

11. The glass forming furnace of claim 1, wherein the cavity has a non-uniform cross-sectional area.

12. The glass forming furnace of claim 1, further comprising a throttling device located within the first channel.

13. A glass forming furnace for forming a glass article, the glass forming furnace comprising:
a housing defining a chamber; and
a bending ring located within the chamber, the bending ring comprising:
a channel having a shape that is similar to a shape of the glass article, the channel defining a cavity,
first and second inlet ports, located proximate a midpoint of the cavity, and
first and second outlet ports fluidly connected to the first and second inlet ports, the first and second outlet ports located proximate respective first and second endpoints of the cavity.

14. The glass forming furnace of claim 13, further comprising:
a heat source located in the housing; and
a heat shield located in between the bending ring and the heat source.

15. The glass forming furnace of claim 13, wherein the bending ring further comprises a plurality of extended surfaces.

16. A method of forming a glass article, the method comprising:
positioning a glass panel on a first bending ring located inside a glass forming furnace;
heating the glass panel within the glass forming furnace; and
passing a fluid through a cavity defined by the first bending ring so as to cool a portion of the glass panel in contact with the first bending ring.

17. The method of claim 16, wherein positioning the glass panel includes positioning the glass panel such that the first bending ring is located proximate edges of the glass panel.

18. The method of claim 16, wherein passing the fluid through the cavity includes passing the fluid in multiple directions through various portions of the cavity.

19. The method of claim 16, further comprising:
positioning a second bending ring to contact the glass panel; and
passing the fluid through a cavity defined by the second bending ring so as to cool the portion of the glass panel in contact with the second bending ring.

20. The method of claim 19, wherein positioning the second bending ring includes positioning the second bending ring on an opposite side of the glass panel from the first bending ring.
